(19) United States
(12) Patent Application Publication
(10) Pub. No.: US 2001/0015411 A1
(43) Pub. Date: Aug. 23, 2001

(54) Laser scanning microscope

(76) Inventors: Yasuo Ohdaira, Kofu-shi (JP); Yoshihiro Shimada, Sagamihara-shi (JP)

Correspondence Address: Frishauf, Holtz, Goodman, Langer & Chick, P. C., 767 Third Avenue - 25th Floor, New York, NY, 10017-2023, US

(21) Appl. No.: 09/746,713

(22) Filed: Dec. 21, 2000

Related U.S. Application Data
(63) Continuation-in-part of application No. 09/652,500, filed on Aug. 31, 2000.

(30) Foreign Application Priority Data
Sep. 24, 1999 (JP) 11-271293

(51) Int. Cl. G01N 21/64

(52) U.S. Cl. 250/458.1

(57) ABSTRACT

A laser beam is applied from a laser unit to a sample, and a fluorescent signal from the sample is converted into an electric signal by a photoelectric converter. Further, a laser oscillation synchronous signal generating circuit generates a laser oscillation synchronous signal that is synchronous with a laser oscillation signal output from the laser unit. The laser oscillation synchronous signal generated by the laser oscillation synchronous signal generating circuit is delayed, by a delay circuit, by an optimal amount determined in light of the attenuation characteristic of fluorescence emitted from the to-be-observed sample. This delayed signal is applied as a sampling signal to an A/D converter. The A/D converter samples the electric signal from the photoelectric converter in synchronism with the sampling signal. As a result, each peak of the fluorescent signal can be sampled.

### CROSS-REFERENCE TO RELATED APPLICATIONS

This is a Continuation-in-Part application of U.S. patent application Ser. No. 09/652,500, filed Aug. 31, 2000, the entire contents of which are incorporated herein by reference.

This application is based upon and claims the benefit of priority from the prior Japanese Patent Application No. 11-271293, filed Sep. 24, 1999, the entire contents of which are incorporated herein by reference.

### BACKGROUND OF THE INVENTION

This invention relates to a fluorescent signal sampling mechanism for use in a laser scanning microscope, in which a pulse laser is used as an excitation light source.

The outline of a laser scanning microscope is described in, for example, a foreign document “HANDBOOK OF BIOLOGICAL CONFOCAL MICROSCOPY” (edited by J. Pawley, PLENUM PRESS, 1990). In general, the laser scanning microscope comprises, as shown in FIG. 1, a light source 1 for oscillating a laser beam; a dichroic mirror 3 for separating the laser beam from the light source 1 and light from a sample 9, which will be described later; a galvanometer mirror 5 for scanning the laser beam in X and Y directions; an objective lens 7 for converging the laser beam onto the sample 9; a pin hole 11 for removing, for example, scattered light from light that is emitted from the sample 9, to thereby extract light in a focal position; a photodetector 13 for receiving light passing through the pin hole 11; and an image processor 15 for receiving an electric signal resulting from photoelectric conversion by the photodetector 13. The image processor 15 converts the electric signal output from the photodetector 13 into a digital signal in synchronism with a sampling clock signal output from, for example, an oscillator (not shown) independent of the processor, then stores the digital signal in a line memory (not shown), executes image processing in synchronism with the scanning of the laser beam, and displays the resultant image data on a monitor display unit 17.

A laser scanning microscope which emits a laser to a sample to detect fluorescence from the sample generally uses laser of continuous wave type such as helium neon laser. However, in recent years, laser beams having various wavelengths are used due to variety of samples to be studied. Some of the lasers oscillates pulses based by a Q switch or a mode locking method in order to limit the fluctuation of an average output due to competition between oscillation modes. Further a mode locked ultra-fast pulse laser is used in the laser scanning microscope as a light source in order to emit light to a sample with extremely high photon density to detect multiphoton fluorescence from the sample. When these pulse lasers are used as the light source, the fluorescence signal from the sample is attenuated with time.

In general, pulses of a laser beam (hereinafter referred to as “laser pulses”) are not synchronized with sampling pulses, and therefore each peak of the fluorescent signal is not always sampled. Accordingly, an image corresponding to a received amount of fluorescence cannot be created, resulting in a dark image. Particularly, since the rate of generation of fluorescence is low in a multiphoton process, and the laser pulses are not synchronized with the sampling pulses, it may be difficult to efficiently sample the fluorescent signal.

### BRIEF SUMMARY OF THE INVENTION

It is an object of the invention to provide a laser scanning microscope using pulse laser excitation, which can reliably sample a fluorescent signal so as to include its peak(s).

According to a first aspect of the invention, there is provided a laser scanning microscope comprising: a pulse laser oscillator configured to oscillate a pulse laser beam to excite a sample; a photodetector configured to detect light from the sample and output an electric signal; a sampling circuit configured to sample the electric signal output from the photodetector in synchronism with oscillation of the pulse laser beam output from the pulse laser oscillator; and a memory configured to accumulate data output from the sampling circuit.

According to a second aspect of the invention, there is provided a laser scanning microscope comprising: a pulse laser oscillator configured to oscillate a pulse laser beam to excite a sample; a photodetector configured to detect light from the sample and output an electric signal; a laser oscillation synchronous signal generating circuit configured to receive a laser oscillation signal from the pulse laser oscillator and generate a laser oscillation synchronous signal; a delay circuit configured to delay the laser oscillation synchronous signal output from the laser oscillation synchronous signal generating circuit, and output the delayed signal as a trigger signal; a pulse generator configured to generate a pulse signal in synchronism with the trigger signal output from the delay circuit; a sampling circuit configured to sample the electric signal output from the photodetector in synchronism with the pulse signal output from the pulse generator; and a memory configured to store a signal sampled by the sampling circuit.

The present invention can make the timing of oscillation of a pulse laser beam coincide with the timing of sampling, which enables reliable sampling of light from a sample. As a result, a brighter image can be obtained than in the case where sampling is executed out of synchronism with the pulses of the laser beam. Moreover, even when the frequency of emission of fluorescence is low, and hence the fluorescent signal is not always generated each time a laser pulse is output, the fluorescent signal can be efficiently acquired by executing sampling in synchronism with laser oscillation, or by continuing sampling for a designated period.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram illustrating a conventional laser scanning microscope;

FIG. 2 is a block diagram illustrating a laser scanning microscope according to an embodiment of the invention;

FIG. 3 is a block diagram illustrating a modification of the laser scanning microscope of FIG. 2;

FIGS. 4A-4E are timing charts useful in explaining the operation of the laser scanning microscope of FIG. 2, FIG. 4A showing a laser oscillation signal, FIG. 4B a fluorescent signal, FIG. 4C a laser oscillation synchronous signal, FIG. 4D a trigger signal, and FIG. 4E sampling data;

FIG. 5 is a block diagram illustrating a laser scanning microscope according to another embodiment of the invention; and

FIGS. 6A-6F are timing charts useful in explaining the operation of the laser scanning microscope of FIG. 5, FIG. 6A showing a laser oscillation signal, FIG. 6B a fluorescent signal, FIG. 6C a laser oscillation synchronous signal, FIG. 6D a trigger signal, and FIG. 6E a pulse signal, and FIG. 6F sampling data.

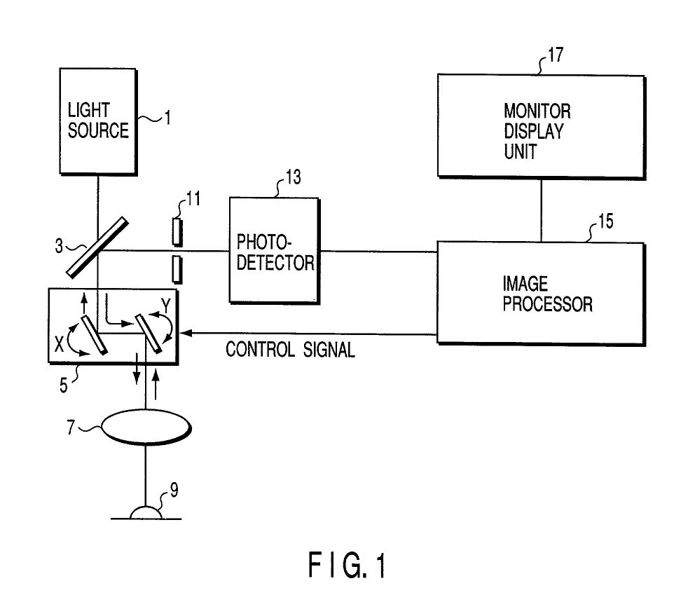

### DETAILED DESCRIPTION OF THE INVENTION

The embodiments of the invention will be described with reference to the accompanying drawings.

### First Embodiment

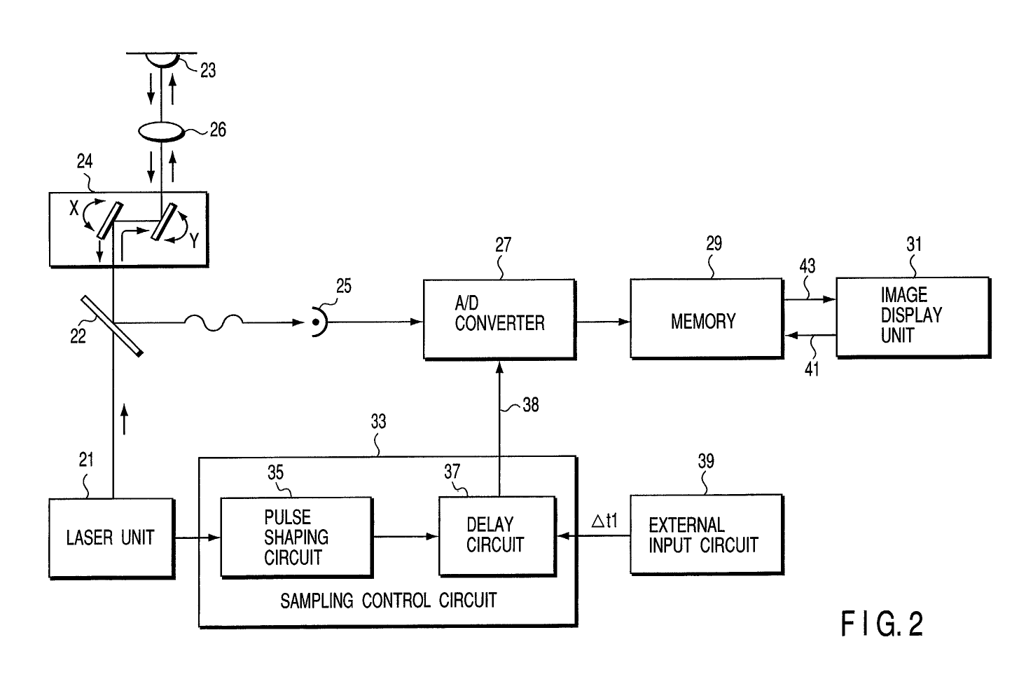

FIG. 2 is a block diagram illustrating a sampling mechanism incorporated in a laser scanning microscope according to an embodiment of the invention. The laser scanning microscope provided with the sampling mechanism shown in FIG. 2 comprises a pulse laser unit 21 for oscillating a pulse laser beam (hereinafter referred to as a “laser beam”) for excitation of a sample; a dichroic mirror 22 for separating a laser beam from the laser unit 21 and fluorescence from a sample 23, which will be described later; a galvanometer mirror 24 for scanning the laser beam in X and Y directions; an objective lens 26 for converging the laser beam onto the sample 23; a photoelectric converter 25 constituted of a photodetector or a photo multiplier for subjecting fluorescence from the sample 23 to photoelectric conversion; an A/D converter 27 having a sample & hold circuit for sampling a signal from the photoelectric converter 25 in synchronism with a signal from the laser unit 21; a memory 29 for storing a digital signal from the A/D converter 27; image display unit 31 for displaying a digital data image (a confocal image) read from the memory 29; and a sampling control circuit 33 for supplying a clock signal for sampling to the A/D converter 27.

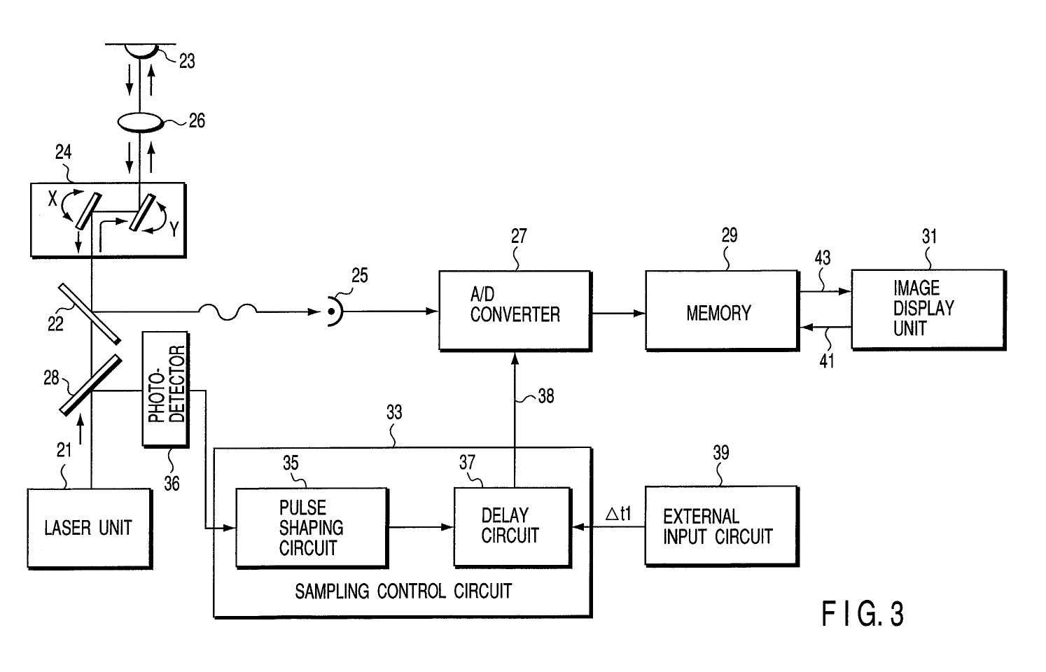

The sampling control circuit 33 includes a pulse shaping circuit 35 and a delay circuit 37. The pulse shaping circuit 35 receives a trigger signal output as an electric signal from the laser unit 21 in synchronism with laser oscillation, then executes waveform shaping and supplies the delay circuit 37 with a laser oscillation synchronous signal of a predetermined pulse width. In the case of a laser unit having no function of outputting an electric signal in synchronism with laser oscillation, a structure as shown in FIG. 3 may be employed. More specifically, a beam splitter 28 is inserted between the dichroic mirror 22 and the laser unit 21, which separates a part of the laser beam oscillated from the laser unit 21. A part of laser beam separated by the beam splitter 28 is subjected to photoelectric conversion by a photodetector 36 or a photo multiplier, and the resultant electric signal is input to the pulse shaping circuit 35. The delay circuit 37 generates a trigger signal obtained by delaying the laser oscillation synchronous signal, output from the pulse shaping circuit 35, by a delay time (Δt1) supplied from an external input circuit 39. This signal is supplied as a sampling clock signal to the A/D converter 27. The delay time (Δt1) is an optimal delay determined in light of the attenuation characteristic of fluorescence emitted from the to-be-observed sample 23. If the attenuation characteristic of fluorescence from the to-be-observed sample 23 is known in advance, a fixed value may be set in the delay circuit 37 as the optimal delay for the attenuation characteristic. In this case, the external input circuit 39 is not necessary.

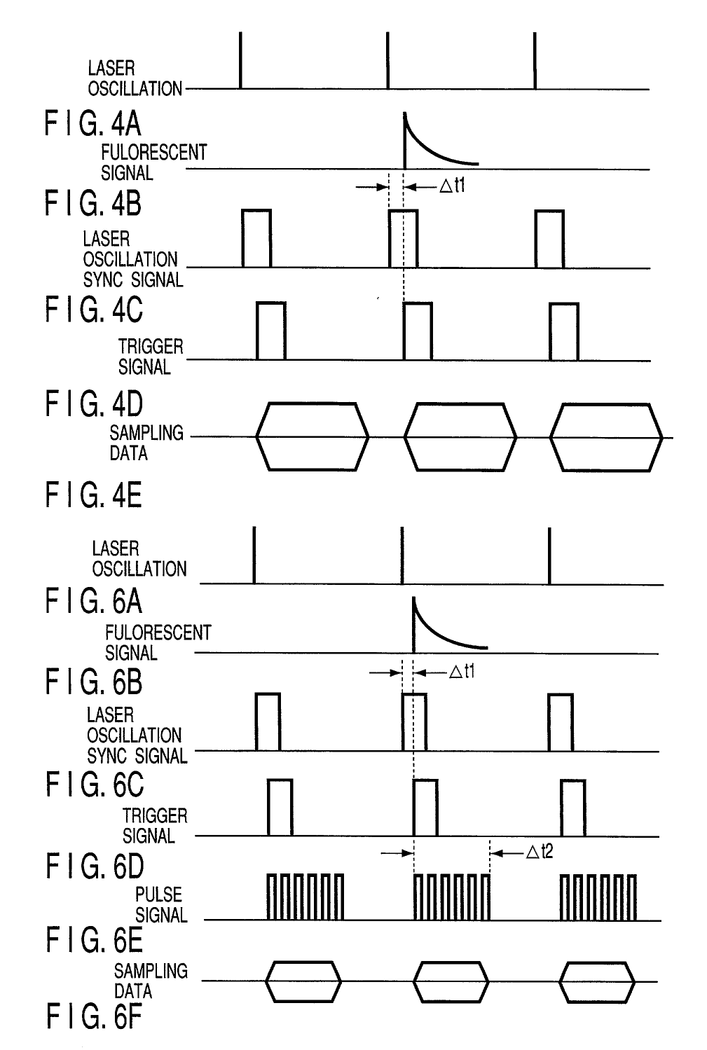

Referring to FIG. 2 and FIGS. 4A-4E, the operation of the embodiment of the invention constructed as above will be described.

In FIG. 2, the laser unit 21 emits a pulse laser as shown in FIG. 4A to the sample 23 via the dichroic mirror 22, the galvanometer mirror 24 and the objective lens 26, and outputs an electric signal synchronous with laser oscillation to the pulse shaping circuit 35 of the sampling control circuit 33. The pulse shaping circuit 35, in turn, generates a laser oscillation synchronous signal, which is as shown in FIG. 4C and has a predetermined pulse width, on the basis of the input electric signal, and outputs it to the delay circuit 37. The laser beam from the laser unit 21 is applied to the sample 23, and then a fluorescent signal as shown in FIG. 4B is input to the photoelectric converter 25. The converter 25 converts the fluorescent signal into an electric signal.

On the other hand, the delay circuit 37 delays the input laser oscillation synchronous signal by a delay time (Δt1) supplied from the external input circuit 39, and outputs a trigger signal 38, as shown in FIG. 4D, to the A/D converter 27. The A/D converter 27, in turn, uses the trigger signal 38 as a sampling clock signal to convert an electric signal (an analog signal) from the photoelectric converter 25, into a digital signal. At this time, the peak of the fluorescent signal can be sampled by making the peak of the fluorescent signal coincide with the sampling timing shown in FIG. 4D. The delay time (Δt1) can be adjusted by comparing the fluorescent signal with the trigger signal after photoelectric conversion, and making the peak of the fluorescent signal coincide with the timing of the trigger signal, or by adjusting the delay time using the external input circuit 39 so that a brightest image can be obtained. The A/D converter 27 converts the electric signal from the photoelectric converter 25 into a digital signal in response to the trigger signal shown in FIG. 4D, thereby outputting sampling data as shown in FIG. 4E to the memory 29. The image display unit 31 supplies the memory 29 with a control signal 41 for reading data stored therein, thereby reading sampling data (digital data) and an address 43 stored therein and then displaying them on its screen in synchronism with the scanning position of the laser beam.

As described above, the peak of the fluorescent signal can be made to coincide with the sampling timing by using the trigger signal as a sampling clock signal, thereby enabling reliable sampling of the peak of the fluorescent signal.

Moreover, this reliable sampling of the peak of the fluorescent signal enables acquisition of a brighter image than in the case of sampling the fluorescent signal out of synchronism with laser oscillation.

In addition, even when the frequency of emission of fluorescence is low and hence a fluorescent signal is not always generated each time a laser pulse is generated, the fluorescent signal can be acquired efficiently by sampling it in synchronism with laser oscillation.

### Second Embodiment

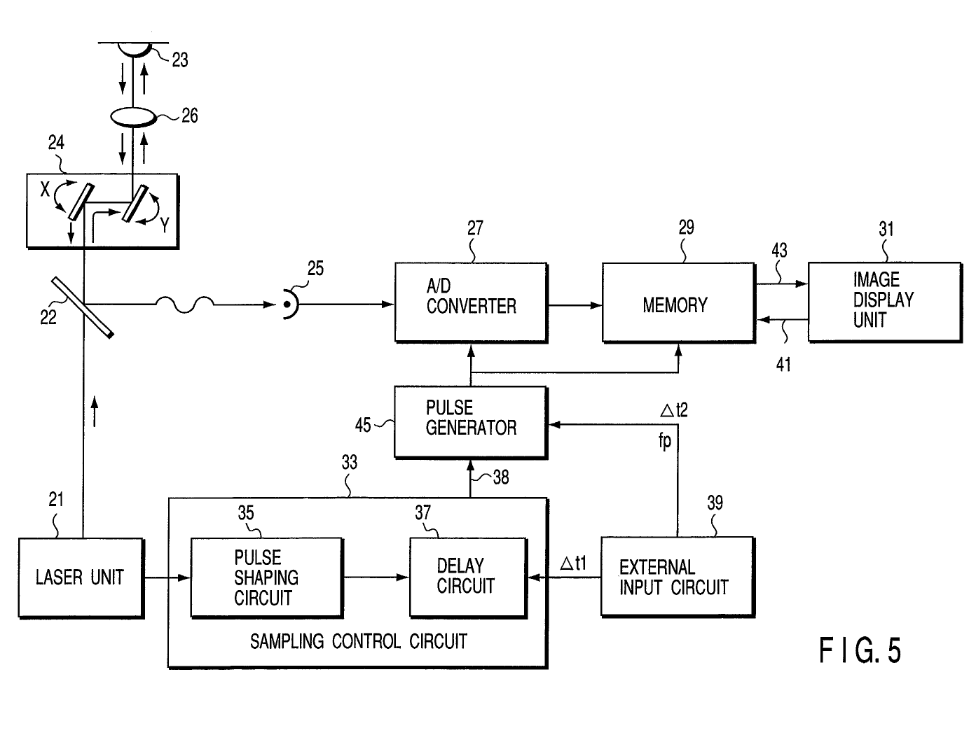

Referring then to FIG. 5 and FIGS. 6A-6F, a second embodiment of the invention will be described. In FIG. 5, elements similar to those in FIG. 2 are denoted by corresponding reference numerals, and are not described in detail.

In this embodiment, a pulse signal output from a pulse generator 45 is used as the sampling clock signal for the A/D converter 27. The pulse generator 45 generates a pulse signal as shown in FIG. 6E in synchronism with the trigger signal 38 output from the delay circuit 37. The frequency fp of the pulse signal and the output period (Δt2) of each pulse of the pulse signal are set arbitrarily using the external input circuit 39. More specifically, the A/D converter 27 executes sampling, using, as a sampling clock signal, a trigger signal from the delay circuit 37, and executes sampling only within each output period (Δt2) (see FIG. 6E). Accordingly, the fluorescent signal, which attenuates with time, can be reliably sampled, without missing its peaks, by adjusting the delay time (Δt1) of the delay circuit 37 and the output period (Δt2) of each pulse of the pulse generator 45. Moreover, timing adjustment can be executed so that no sampling is executed where no fluorescent signal is generated. For example, when applying the above-described structure to a laser scanning microscope that uses a two-photon process, if sampling is executed one hundred times during the generation of one pulse of a laser beam, the above structure can be used by setting the output period (Δt2) at 10 ns or less and setting the frequency of the pulse signal of the pulse generator 45 at about 10 GHz, since, in the two-photon process, a laser beam with a pulse frequency of 80 MHz and with a pulse width of 100 fs.

As is evident from the above, a brighter image can be obtained by reliably sampling the fluorescent signal than in the case of executing sampling out of synchronism with laser oscillation. Also, there may be a case where the frequency of emission of fluorescence is low, and hence the fluorescent signal is not always generated each time a laser pulse is generated. Even in this case, the fluorescent signal can be acquired efficiently by sampling it in synchronism with laser oscillation. Furthermore, since the fluorescent signal is reliably sampled without missing its peak(s), and stored in the memory 29, digital processing using the digital data, such as digital integration of the fluorescent signal, analysis of the maximum value of the fluorescent signal, analysis of the time constant of the fluorescent signal, etc., can be executed. In addition, since the sampling is not executed where no fluorescent signal is generated, only necessary sampled data can be stored in the memory 29, thereby reducing the memory capacity. Therefore, the remaining memory capacity can be used effectively.

The present invention is not limited to the above-described embodiments, but can be modified in various ways without departing from its scope. For example, the fluorescent signal may be sampled in synchronism with laser oscillation by the laser unit, without using a delay circuit. Alternatively, the fluorescent signal may be sampled in synchronism with the emission of fluorescence from a sample, using, as a synchronous signal, an electric signal output from the photoelectric converter.

Further it may be constructed such that a part of the laser beam oscillated from the laser unit is separated by the beam splitter, as is the structure explained in FIG. 3 in the second embodiment. And a part of the laser beam oscillated from the laser unit is separated by the beam splitter. The part of the laser beam separated by the beam splitter is subjected to photoelectric conversion by the photodetector or the like and the resultant electric signal is inputted to the pulse shaping circuit.

Note that the laser unit used in the present invention may be implemented by a mode locked ultra fast pulse laser for dual photon excitation or a pulse laser for a single photon excitation.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A laser scanning microscope comprising:
a pulse laser oscillator configured to oscillate a pulse laser beam to excite a sample;
a photodetector configured to detect light from the sample and output an electric signal;
a sampling circuit configured to sample the electric signal output from the photodetector in synchronism with oscillation of the pulse laser beam output from the pulse laser oscillator; and
a memory configured to accumulate data output from the sampling circuit.

2. The laser scanning microscope according to claim 1, further comprising a synchronous signal generating circuit configured to detect oscillation of the pulse laser beam from the pulse laser oscillator, and output a synchronous signal in synchronism with the oscillation of the pulse laser beam, and wherein the sampling circuit samples the electric signal from the photodetector in synchronism with the synchronous signal from the synchronous signal generating circuit.

3. The laser scanning microscope according to claim 2, wherein the synchronous signal generating circuit has a delay circuit configured to output a trigger signal obtained by delaying the synchronous signal, and the sampling circuit samples the electric signal from the photodetector in synchronism with the synchronous signal delayed by the delay circuit.

4. The laser scanning microscope according to claim 3, further comprising a pulse generator configured to generate a pulse signal in synchronism with the synchronous signal delayed by the delay circuit, and wherein the sampling circuit samples the electric signal from the photodetector in response to the pulse signal from the pulse generator.

5. The laser scanning microscope according to claim 3, wherein a delay set by the delay circuit is a fixed value.

6. The laser scanning microscope according to claim 3, further comprising means for changing a delay set by the delay circuit.

7. The laser scanning microscope according to claim 1, wherein the pulse laser oscillator is a mode locked ultra fast pulse laser which detects fluorescence from the sample due to multiphoton excitation.

8. A laser scanning microscope comprising:
a pulse laser oscillator configured to oscillate a pulse laser beam to excite a sample;
a photodetector configured to detect light from the sample and output an electric signal;
a laser oscillation synchronous signal generating circuit configured to receive a laser oscillation signal from the pulse laser oscillator and generate a laser oscillation synchronous signal;
a delay circuit configured to delay the laser oscillation synchronous signal output from the laser oscillation synchronous signal generating circuit, and output the delayed signal as a trigger signal;
a sampling circuit configured to sample the electric signal output from the photodetector in synchronism with oscillation of the trigger signal output from the delay circuit; and
a memory configured to accumulate data outputted from the sampling circuit.

9. The laser scanning microscope according to claim 8, wherein a delay set by the delay circuit is a fixed value.

10. The laser scanning microscope according to claim 8, further comprising means for changing a delay set by the delay circuit.

11. The laser scanning microscope according to claim 8, wherein the pulse laser oscillator is a mode locked ultra fast pulse laser which detects fluorescence from the sample due to multiphoton excitation.

12. A laser scanning microscope comprising:
a pulse laser oscillator configured to oscillate a pulse laser beam to excite a sample;
a photodetector configured to detect light from the sample and output an electric signal;
a laser oscillation synchronous signal generating circuit configured to receive a laser oscillation signal from the pulse laser oscillator and generate a laser oscillation synchronous signal;
a delay circuit configured to delay the laser oscillation synchronous signal output from the laser oscillation synchronous signal generating circuit, and output the delayed signal as a trigger signal;
a pulse generator configured to generate a pulse signal in synchronism with the trigger signal output from the delay circuit;
a sampling circuit configured to sample the electric signal output from the photodetector in synchronism with the pulse signal output from the pulse generator; and
a memory configured to accumulate data outputted from the sampling circuit.

13. The laser scanning microscope according to claim 12, wherein the pulse generator outputs the pulse signal during an output period in which an external input circuit outputs a signal to the microscope, and the sampling circuit samples, during the output period, the electric signal output from the photodetector.

14. The laser scanning microscope according to claim 12, wherein a delay set by the delay circuit is a fixed value.

15. The laser scanning microscope according to claim 12, further comprising means for changing a delay set by the delay circuit.
